(19) United States
(12) Patent Application Publication
(10) Pub. No.: US 2026/0141502 A1
(43) Pub. Date: May 21, 2026

(54) CAMERA IMAGE QUALITY TESTING AND CORRECTION

(71) Applicant: Google LLC, Mountain View, CA (US)

(72) Inventors: Richard Cheng-I Yeh, Brooklyn, NY (US); Peter Sherman, San Jose, CA (US)

(21) Appl. No.: 18/953,883

(22) Filed: Nov. 20, 2024

(51) Int. Cl. G06T 7/00; G06T 7/80; H04N 17/00; H04N 23/60

(52) U.S. Cl. CPC G06T 7/0002; G06T 7/80; H04N 17/002; H04N 23/64; G06T 2200/24; G06T 2207/10016; G06T 2207/30168

(57) ABSTRACT

A method for camera image quality testing and correction includes obtaining an image captured by an image capture device. The method includes obtaining data indicating one or more image parameter values. Each parameter value of the one or more image parameter values can correspond to a respective image parameter of the captured image. The method includes converting each image parameter value of the one or more image parameter values into a respective vector space. The method includes converting each image parameter value in the respective vector space of the one or more image parameter values in the respective vector spaces into a respective raw score. The method includes, responsive to a raw score of the one or more raw scores not satisfying a threshold score, causing a corrective action associated with the image parameter corresponding to the image parameter value from which the raw score was derived to be performed.

### TECHNICAL FIELD

Aspects and implementations of the present disclosure relate to virtual meetings and more specifically to camera image quality testing and correction.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for camera image quality testing and correction. The method includes obtaining an image captured by an image capture device. The method includes obtaining data indicating one or more image parameter values. Each parameter value of the one or more image parameter values can correspond to a respective image parameter of the captured image. The method includes converting each image parameter value of the one or more image parameter values into a respective vector space. The method includes converting each image parameter value in the respective vector space of the one or more image parameter values in the respective vector spaces into a respective raw score of one or more raw scores. The method includes, responsive to a raw score of the one or more raw scores not satisfying threshold score, causing a corrective action associated with the image parameter corresponding to the image parameter value from which the raw score was derived to be performed.

Another aspect of the disclosure provides a system. The system includes a memory and a processing device coupled with the memory. The processing device is configured to perform operations. The operations include obtaining an image captured by an image capture device. The operations include obtaining data indicating one or more image parameter values. Each parameter value of the one or more image parameter values can correspond to a respective image parameter of the captured image. The operations include converting each image parameter value of the one or more image parameter values into a respective vector space. The operations include converting each image parameter value in the respective vector space of the one or more image parameter values in the respective vector spaces into a respective raw score of one or more raw scores. The operations include, responsive to a raw score of the one or more raw scores not satisfying a threshold score, causing a corrective action associated with the image parameter corresponding to the image parameter value from which the raw score was derived to be performed.

Another aspect of the disclosure provides a non-transitory computer-readable storage medium with instructions that, when executed by a processing device, cause the processing device to perform operations. The operations include obtaining an image captured by an image capture device. The operations include obtaining data indicating one or more image parameter values. Each parameter value of the one or more image parameter values can correspond to a respective image parameter of the captured image. The operations include converting each image parameter value of the one or more image parameter values into a respective vector space. The operations include converting each image parameter value in the respective vector space of the one or more image parameter values in the respective vector spaces into a respective raw score of one or more raw scores. The operations include, responsive to a raw score of the one or more raw scores not satisfying a threshold score, causing a corrective action associated with the image parameter corresponding to the image parameter value from which the raw score was derived to be performed.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for camera image quality testing and correction, in accordance with some implementations of the present disclosure.

FIG. 2 illustrates a schematic block diagram for an artificial intelligence (AI) training subsystem of a virtual meeting platform, in accordance with some implementations of the present disclosure.

FIG. 3 illustrates a schematic block diagram for an AI inference subsystem of a virtual meeting platform, in accordance with some implementations of the present disclosure.

FIG. 4 depicts a flow diagram of a method for camera image quality testing and correction, in accordance with some implementations of the present disclosure.

FIG. 5 illustrates an example system architecture for a virtual meeting system using camera image quality testing and correction, in accordance with some implementations of the present disclosure.

FIG. 6 depicts a virtual meeting user interface (UI) for a virtual meeting, in accordance with some implementations of the present disclosure.

FIG. 7 is a block diagram illustrating an example computer system, in accordance with some implementations of the present disclosure.

### DETAILED DESCRIPTION

A virtual meeting platform can enable video-based conferences between multiple participants via respective client devices that are connected over a network and share each other's audio (e.g., voice of a user recorded via a microphone of a client device) and/or video streams (e.g., a video captured by an image capture device (e.g., a camera) associated with a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

Participants of a virtual meeting can use different image capture devices in order to produce video streams during the virtual meeting. However, not all image capture devices produce images or videos of the same quality. Different image capture devices can produce images with image parameters of different quality. Such image parameters may include exposure, color accuracy, sharpness, texture, noise, latency, or the presence of artifacts in an image. It can be difficult for participants of a virtual meeting to compare image capture devices and the quality of their respective image parameters in order for participants to select an image capture device satisfactory to the participant's needs, leading to inconsistent image quality in virtual meetings. As such, some images presented during a virtual meeting may be of a subpar quality. Consequently, some images presented during a virtual meeting may be subpar, which can negatively impact virtual meeting participants'experiences.

Implementations of the present disclosure address the above and other deficiencies by providing a system that can test the image quality of an image capture device. The system can obtain an image captured by the image capture device. The system can obtain data indicating one or more image parameter values each corresponding to an image parameter of the captured image. The system can convert each image parameter value into a vector space and convert the vector space image parameter value into a raw score for the image parameter. The raw scores for the different image parameters can then be used for a variety of applications. For example, responsive to determining that a raw score does not satisfy a threshold score, the system can cause a corrective action to be performed (e.g., adjusting the camera to improve the raw score or adjusting the captured image to improve the low-quality image parameter). In another example, the raw scores can be displayed to users (e.g., potential purchasers of image capture devices) to help them compare the quality of the image capture devices and select the one that best meets their needs.

Aspects of the present disclosure provide technical advantages over previous solutions. One technical problem associated with an image capture device includes poor image quality of images captured by the image capture device. One of the technical solutions to the technical problem may include determining raw scores for different image parameters of the image capture device and automatically adjusting the image capture device to improve the image parameters of the image capture device. Thus, aspects of the present disclosure improve the quality of images and/or videos such as a participant's video stream during a virtual meeting.

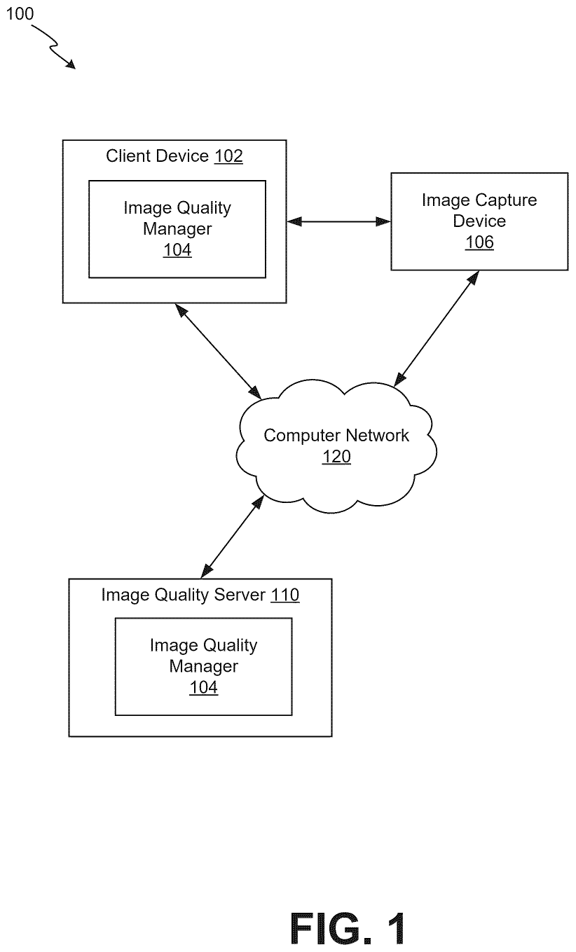

FIG. 1 illustrates an example system architecture 100. The system architecture 100 may include a system for camera image quality testing and correction, in accordance with some implementations. The system 100 may include a client device 102, an image capture device 106, an image quality server 110, and/or a computer network 120. The client device 102 or the image quality server 110 may include an image quality manager 104. The client device 102, the image capture device 106, or the image quality server 110 may be in data communication over the computer network 120.

In some implementations, the client devices 102 includes a computing device such as a personal computer (PC), laptop, mobile phone, smart phone, tablet computer, netbook computer, network-connected television, etc. The client device 102 can also be referred to as a “user device.” A user of the client device 102 can operate the client device 102. In some implementations of the disclosure, a “user” can be represented as a single individual. However, other implementations of the disclosure encompass a “user” being an entity controlled by a set of users or an organization. In situations in which the systems discussed here collect personal information about users, or can make use of personal information, the users can be provided with an opportunity to control whether the image quality server 110 collects user information (e.g., information about a user's social network, social actions or activities, profession, a user's preferences, or a user's current location), or to control whether and/or how to receive content from the image quality server 110 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the image quality server 110.

The client device 102 may include an image quality manager 104. The image quality manager 104 may include a mobile application, a desktop application, a web browser, etc. The image quality manager 104 can perform operations to test or control the image capture device 106, or the image quality manager 104 can perform operations to adjust an image captured from the image capture device to improve the quality of the captured image. In some implementations, the image quality manager 104 is in data communication with the image quality server 110 and performs one or more of the operations responsive to obtaining instructions, commands, requests, or other data from the image quality server 110. For example, the image quality server 110 may execute in a cloud computing environment and may send data to the image quality manager 104 on the client device 102, which may cause the image quality manager 104 to perform the one or more operations. The image quality server 110 may include a cloud service or may be in data communication with a cloud service of the client device 102.

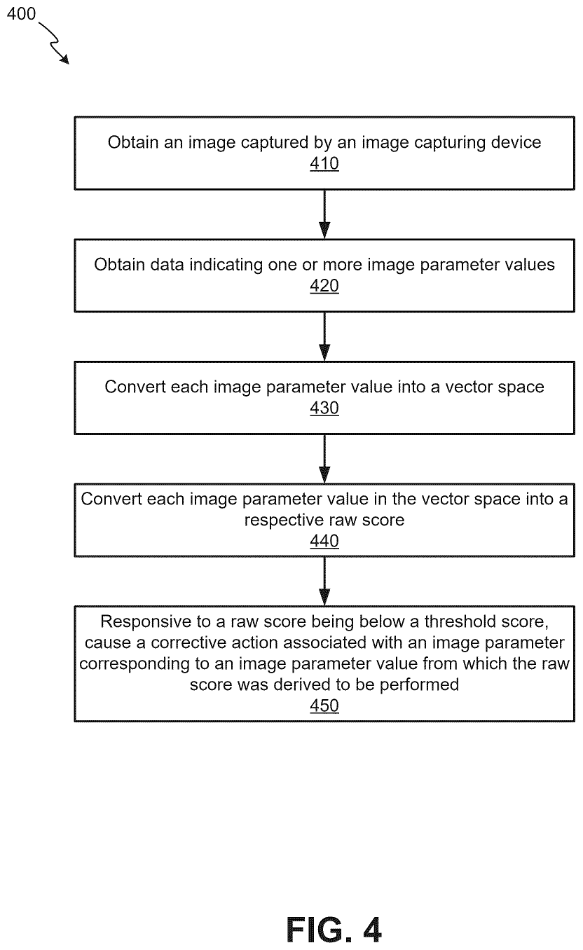

In some implementations, the image quality manager 104 includes a software application (or subset thereof) that performs camera image quality testing and correction functionality. The image quality manager 104 can obtain one or more images captured by the image capture device 106, obtain image parameter values for the one or more captured images, convert the image parameter values into a vector space, and convert the vector space image parameter values into raw scores. The image quality manager 104 can use the raw scores to perform various operations associated with the image capture device 106. For example, the image quality manager 104 can determine that a raw score for a certain image parameter does not satisfy a threshold score associated with the image parameter and, in response, cause a corrective action associated with the image parameter to be performed. Further information regarding the testing manager 112 is provided below in relation to FIG. 4.

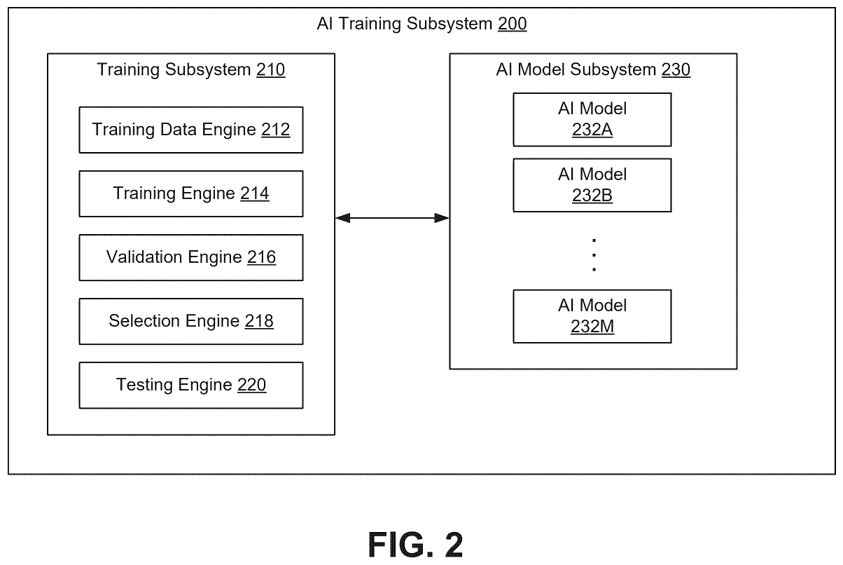

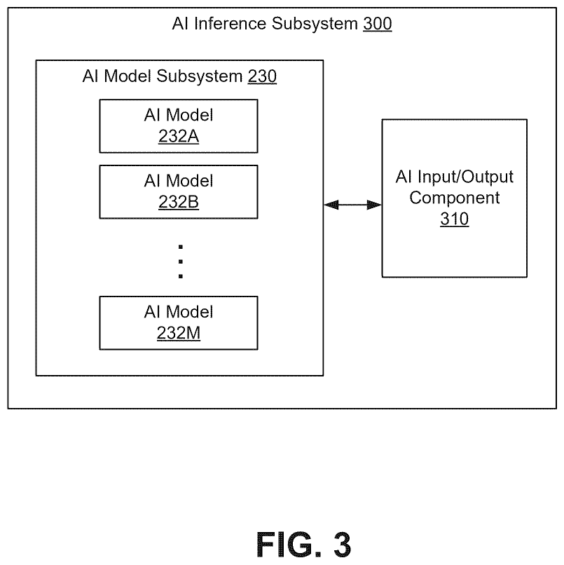

As discussed above, the image quality manager 104 may obtain one or more image parameter values for an image captured by the image capture device 106. For example, the image quality manager 104 can obtain an image parameter value from a file that includes the captured image or from another component of the system (e.g., an image processing application on the client device 102 or the image quality server 110). In some implementations, the image quality manager 104 uses an artificial intelligence (AI) model to determine the image parameter value. The image quality manager 104 may include an AI inference subsystem that includes one or more AI models trained to determine image parameter values for captured images. Further information regarding using an AI model is provided below in relation to FIG. 2 and FIG. 3.

In some implementations, the image capture device 106 includes a device configured to capture images or video using an image sensor and other components. The image capture device 106 may include a camera, such as a webcam, a camera built into a mobile device, or a conference room camera. The image capture device 106 can be in data communication with the client device 102. For example, the image capture device 106 may be connected to the client device 102 using a cable (e.g., a Universal Serial Bus (USB) cable) or a wireless connection (e.g., Wi-Fi) or the image capture device 106 can be embedded into the circuitry of the client device 102. In another example, the image capture device 106 may be in data communication with the client device 102 over the computer network 120 (e.g., the image capture device 106 may include an Internet Protocol (IP) camera). The image capture device 106 can send one or more captured images to the client device 102. In some implementations, the image capture device 106 includes firmware that operates one or more components of the image capture device 106.

In one implementation, the image quality server 110 includes one or more computing devices. A computing device may include a physical computing device or may include a virtualized component, such as a virtual machine (VM) or a container. A computing device may include an instance of a computing device. An instance of a computing device may include a spun-up instance that may not be specific to any computing device. In some implementations, a VM includes a system virtual machine, which may include a VM that emulates an entire physical computing device. A VM may include a process virtual machine, which may include a VM that emulates an application or some other software. A container may include a computing environment that logically surrounds one or more software applications independently of other applications executing in a cloud computing environment.

The image quality server 110 may include the image quality manager 104. The image quality server 110 may include one or more computing devices that include more computing resources (e.g., processing power, memory, data storage, etc.) than the client device 102 and, thus, the image quality manager 104 being hosted on the image quality server 110 can be more efficient than the image quality manager 104 being hosted on the client device 102. In some implementations, the client device 102 may include the image quality manager 104. The image quality manager 104 being hosted on the client device 102 can allow the client device 102 to perform camera image quality testing and correction operations without sending images obtained from the image capture device 106 over the computer network 120 or without waiting for computing resources of the image quality server 110 to be freed up from other uses. In some implementations, one or more portions of the image quality manager 104 may be hosted on the client device 102, and other portions of the image quality manager 104 may be hosted on the image quality server 104. The different portions of the image quality manager 104 may be in data communication over the computer network 120.

In some implementations, the computer network 120 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

FIG. 2 illustrates an example AI training subsystem 200, in accordance with implementations of the present disclosure. The AI training subsystem 200 may be configured to train one or more AI models for use by one or more components of the system 100. The image quality server 110 may include the AI training subsystem 200, or the AI training subsystem 200 may be part of another computing device in data communication with the image quality manager 104 over the computer network 120. As illustrated in FIG. 2, the AI training subsystem 200 may include a training subsystem 210, which may include a training data engine 212, a training engine 214, a validation engine 216, a selection engine 218, or a testing engine 220. The AI training subsystem 200 may include an AI model subsystem 230. The AI model subsystem 230 may include one or more AI models 232A-M.

In one implementation, the AI model 232A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 232A-M is an AI model that has been trained on a corpus of data. In some implementations, the AI model 232A-M can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-M to learn broad elements including, image or speech recognition, general sentence structure, common phrases, vocabulary, natural language structure, and other elements. In some implementations, this first, foundational model is trained using self-supervision, or unsupervised training on such datasets.

In some implementations, the AI model 232A-M is then further trained or fine-tuned on organizational data, including proprietary organizational data. The AI model 232A-M can also be further trained or fine-tuned on organizational data associated with camera image quality testing and correction.

In some implementations, the second portion of training, including fine-tuning, may be unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-M while training can be ranked by a user, according to a variety of factors, including accuracy, helpfulness, veracity, acceptability, or any other metric useful in the fine-tuning portion of training. In this manner, the AI model 232A-M can learn to favor these and any other factors relevant to users when generating a response. Further details regarding training are provided below.

In some implementations, an AI model 232A-M includes one or more pre-trained models, or fine-tuned models. In a non-limiting example, in some implementations, the goal of the “fine-tuning” is accomplished with a second, or third, or any number of additional models. For example, the outputs of the pre-trained model can be input into a second AI model 232A-M that has been trained in a similar manner as the “fine-tuned” portion of training above. In such a way, two more AI models 232A-M can accomplish work similar to one model that has been pre-trained, and then fine-tuned.

As indicated above, an AI model 232A-M may be one or more generative AI models 232A-M, allowing for the generation of new and original content. The generative AI model 232A-M can use other machine learning models including an encoder-decoder architecture including one or more self-attention mechanisms, and one or more feed-forward mechanisms. In some implementations, the generative AI model 232A-M includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model 232A-M can also utilize the previously discussed deep learning techniques, including RNNs, CNNs, or transformer networks. Further details regarding generative AI models 232A-M are provided herein.

In some implementations, different AI models 232A-M of the one or more AI models 232A-M are different types of AI models 232A-M. Multiple AI models 232A-M of the one or more AI models 232A-M can form an ensemble.

In one implementation, the training subsystem 210 manages the training and testing of the one or more AI models 232A-M. The training data engine 212 can generate training data (e.g., a set of training inputs and a set of target outputs) to train an AI model 232A-M. In an illustrative example, the training data engine 212 can initialize a training set T to null. The training data engine 212 can add the training data to the training set T and can determine whether training set T is sufficient for training the AI model 232A-M. The training set T can be sufficient for training the AI model 232A-M if the training set T includes a threshold amount of training data, in some implementations. In response to determining that the training set T is not sufficient for training, the training data engine 212 can identify additional training data and add it to the training set T. In response to determining that the training set T is sufficient for training, the training data engine 212 can provide the training set T to the training engine 214.

A piece of training data may include a training input that includes an image. The piece of training data may include a corresponding target output that includes one or more image parameter values for the image of the training input. In some implementations, the training input including an image includes the training input includes an embedding based on the image. The embedding may include a vector embedding that encodes the image into a format compatible with the AI model 232A-M.

The training engine 214 can train the AI model 232A-M using the training data (e.g., training set T). The AI model 232A-M can refer to the model artifact that is created by the training engine 214 using the training data, where such training data can include training inputs and, in some implementations, corresponding target outputs (e.g., correct answers for respective training inputs). The training engine 214 can input the training data into the AI model 232A-M so that the AI model 232A-M can find patterns in the training data and configure itself based on those patterns.

Where the AI model 232A-M uses supervised learning, the training engine 214 can assist the AI model 232A-M in determining whether the AI model 232A-M maps the training input to the target output (the answer to be predicted). Where the AI model 232A-M uses unsupervised learning, the training engine 214 can input the training data into the AI model 232A-M. The AI model 232A-M can configure itself based on the input training data, but since the training data may not include a target output, the training engine 214 may not assist the AI model 232A-M in determining whether the AI model 232A-M provided a correct output during the training process.

The validation engine 216 may be capable of validating a trained AI model 232A-M using a corresponding set of features of a validation set from the training data engine 212. The validation engine 216 can determine an accuracy of each of the trained AI models 232A-M based on the corresponding sets of features of the validation set. Where the training data may not include a target output, validating a trained AI model 232A-M may include obtaining an output from the AI model 232A-M and providing the output to another entity for evaluation. The other entity may include another AI model configured to evaluate the output of the AI model that is undergoing training. The other entity may include a human. The validation engine 216 can discard a trained AI model 232A-M that has an accuracy that does not meet a threshold accuracy or that otherwise fails evaluation. In some implementations, the selection engine 218 is capable of selecting a trained AI model 232A-M that has an accuracy that meets a threshold accuracy. In some implementations, the selection engine 218 is capable of selecting the trained AI model 232A-M that has the highest accuracy of multiple trained AI models 232A-M. In some implementations, the selection engine 218 obtains input from another AI model or a human and can select a trained AI model 232A-M based on the input.

The testing engine 220 may be capable of testing a trained AI model 232A-M using a corresponding set of features of a testing set from the training data engine 212. For example, a first trained AI model 232A-M that was trained using a first set of features of the training set may be tested using the first set of features of the testing set. The testing engine 220 can determine a trained AI model 232A-M that has the highest accuracy or other evaluation of all of the trained AI models 232A-M based on the testing sets.

As described above, the AI training subsystem 200 can be configured to train an LLM. It should be noted that the AI training subsystem 200 can train an LLM in accordance with implementations described herein or in accordance with other techniques for training LLMs. For example, an LLM may be trained on a large amount of data, including prediction of one or more missing words in a sentence, identification of whether two consecutive sentences are logically related to each other, generation of next texts based on prompts, etc.

In some implementations, the AI model subsystem 230 selects an AI model 232A-M from the one or more AI models 232A-M. Selecting an AI model 232A-M may include selecting the AI model 232A-M for training or for use. For example, the training subsystem 210 can provide data to the AI model subsystem 230 indicating which AI model 232A-M is to be trained. The AI model subsystem 230 can obtain data from a component of the system 100 indicating which AI model 232A-M to use to generate output.

FIG. 3 depicts one implementation of an AI inference subsystem 300. The AI inference subsystem 300 may include the AI model subsystem 230, which may include one or more AI models 232A-M. The AI inference subsystem 300 may include an AI input/output component 310. The AI input/output component 310 may be configured to feed data as input to an AI model 232A-M and obtain one or more outputs. In such implementations, the AI input/output component 310 feeds one or more captured images as input to an AI model 232A-M and obtains one or more outputs.

In some implementations, the AI inference subsystem 300 is not part of the image quality manager 104 and may, instead, be part of another system or sub-system or be an independent system. In some implementations, the AI inference system 300 includes the AI training system 200.

As indicated above, an AI model 232A-M may include a generative AI model 232A-M, such as an LLM. In some implementations, the generative AI model 232A-M includes generative AI functionality. In such implementations, the generative AI model 232A-M generates new content based on provided input data. The input data may include one or more captured images from the image capture device 106. The new content may include one or more image parameter values for the input one or more captured images.

In some implementations, the generative AI model 232A-M is supported by a prompt subsystem. The prompt subsystem may be part of the AI inference subsystem 300. For example, the prompt subsystem may be in data communication with the AI input/output component 310, or the prompt subsystem may be part of the AI input/output component 310.

The prompt subsystem can enable a component of the system 100 to access a generative AI model 232A-M of the AI inference subsystem 300. The prompt subsystem may be configured to perform automated identification of, and facilitate retrieval of, relevant and timely contextual information for efficient and accurate processing of prompts by the AI model 232A-M. Using the data network 120 (or another network), the prompt subsystem may be in communication with one or more of the client device 102, the image quality manager 104, or the image quality server 110. Communications between the prompt subsystem and the AI input/output component 310 may be facilitated by a generative model application programming interface (API), in some implementations. Communications between the prompt subsystem and client device 102, the image quality manager 104, or the image quality server 110 may be facilitated by a data management API. In additional or alternative implementations, the generative model API translates prompts generated by the prompt subsystem into unstructured natural-language format and, conversely, translate responses received from the AI model 232A-M into any suitable form (e.g., including any structured proprietary format as may be used by the prompt subsystem). Similarly, the data management API can support instructions that may be used to communicate data requests to client device 102, the image quality manager 104, or the image quality server 110, and formats of data received from such components.

In some implementations, the prompt subsystem includes a prompt analyzer to support various operations of this disclosure. For example, the prompt analyzer can receive an input (e.g., a prompt submitted by a component of the system 100) and generate one or more intermediate prompts to the generative AI model 232A-M to determine what type of data the generative AI model 232A-M may need to successfully respond to the input. Upon receiving a response from the generative AI model 232A-M, the prompt analyzer can analyze the response, form a request for relevant contextual data from a data store (e.g., a data store associated with the image quality server 110 (not shown)), which can then supply such data. The prompt analyzer can then generate a prompt to the generative AI model 232A-M that includes the original prompt and the contextual data. In some implementations, the prompt analyzer, itself, includes a lightweight generative AI model that can process the intermediate prompt(s) and determine what type of contextual data may be needed by the generative AI model 232A-M together with the original prompt to ensure a meaningful response from generative AI model 232A-M.

The prompt subsystem may include (or may have access to) instructions stored on one or more tangible, machine-readable storage media of a computing device (e.g., the client device 102 or the image quality server 110) and executable by one or more processing devices of the computing device. In one implementation, the prompt subsystem is implemented on a single machine. In some implementations, the prompt subsystem is a combination of a client component and a server component. In some implementations, the prompt subsystem is executed entirely on the client device 102. Alternatively, some portion of the prompt subsystem may be executed on a client device 102 while another portion of the prompt subsystem may be executed on the image quality server 110.

In one implementation, a prompt provided to the prompt subsystem may include one or more images captured by the image captured device 106. The prompt may further include a command for the generative AI model 232A-M. The command may include text data or other data instructing the generative AI model 232A-M regarding the one or more captured images included in the prompt. For example, the command may include a command to determine one or more image parameter values for the one or more captured images.

FIG. 4 is a flowchart illustrating one embodiment of a method 400 for camera image quality testing and correction, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some implementations, the image quality manager 104 performs one or more of the operations of the method 400.

At block 410, processing logic obtains an image captured by the image capture device 106. The image capture device 106 may capture an image and provide the captured image to the client device 102 or the image quality server 110. The client device 102 or the image quality server 110 may then provide the captured image to the image quality manager 104.

In some implementations, the captured image includes an image of a testing environment. The testing environment may include a controlled space configured to assist in evaluating the performance of an image capture device 106. The testing environment may be “controlled” in that one or more aspects of the testing environment (e.g., lighting, calibration images, objects, etc.) can conform to predetermined conditions so that such aspects are reproducible or made consistent at different times in order to test different image capture devices 106. In one implementation, the captured image includes an image of a virtual meeting participant's environment around a client device 102 used by the participant to engage in the virtual meeting.

In some implementations, processing logic obtains multiple images that the image capture device 106 captured sequentially. For example, the multiple images may include frames of a video captured by the image capture device 106. The image quality manager 104 may obtain multiple, sequential images in order for the image quality manager 104 to determine certain image parameters for the multiple images, such as exposure, which may include determining a reaction time of the image capture device 106.

At block 420, processing logic obtains data indicating one or more image parameter values. Each image parameter value of the one or more image parameter values may correspond to a respective image parameter of the captured image.

An image parameter of an image may include an image quality metric. An image quality metric may include a measurable or quantifiable aspect or characteristic of the image. An image parameter value may include a measurement of the corresponding image parameter.

In one implementation, an image parameter of the captured image includes an exposure of the captured image. An exposure of the captured image may indicate an amount of light that reaches the sensor of the image capture device 106. An image parameter of the captured image may include a color accuracy of the captured image. Color accuracy may indicate how closely the colors in the captured image match the colors in the real-world scene. An image parameter of the captured image may include a sharpness of the captured image. Sharpness (sometimes referred to as “focus”) may indicate a degree to which the captured image has clear edges, well-defined lines, or visible textures.

An image parameter of the captured image may include a noise of the captured image. Noise may indicate the presence of undesired variations in brightness or color in the captured image. Noise in an image may appear as graininess, speckles, or other visual indications that degrade the image quality of the image. An image parameter of the captured image may include the presence of artifacts in the image. Artifacts in the image may include unwanted elements introduced into the image during the capture or processing of the image. An artifact may be introduced into the image as a result of a lens imperfection of the lens of the image capture device 106. An artifact may be introduced as a result of compressing the file that contains the image. An artifact may be introduced as a result of image processing software processing the image.

In some implementations, an image parameter value may include data quantifying the corresponding image parameter. For example, the image parameter value related to exposure may include the exposure value of the captured image. In another example, the image parameter value related to color accuracy may include one or more colorimetric measurement values. In yet another example, the image parameter value related to sharpness may include a spatial frequency response value of the image.

As discussed above, the image quality manager 104 may obtain an image parameter value in a variety of ways. The image quality manager 104 may obtain an image parameter value from the captured image. For example, the captured image may include metadata indicating an exposure of the image. The image quality manager 104 may obtain an image parameter value from image processing software. For example, the client device 102 or the image quality server 110 may include image processing software that uses the captured image as input and generates one or more image parameter values for the image.

The image quality manager 104 may obtain an image parameter value from the AI inference subsystem 300, which may be part of the image quality manager 104 or may otherwise be part of the client device 102 or the image quality server 110. For example, the image quality manager 104 may provide the captured image to the AI input/output component 310 of the AI inference subsystem 300. The AI input/output component 310 may provide the image to an AI model 232A-M that has been trained to determine one or more image parameter values for images. The AI model 232A-M may generate an output that includes the one or more image parameter values. The AI model 232A-M may provide the output to the AI input/output component 310, which may then provide the one or more image parameter values to the image quality manager 104.

At block 430, processing logic converts each image parameter value of the one or more image parameter values into a respective vector space. In one implementation, each image parameter has a respective corresponding vector space. The respective unit vector for the different image parameters'vector spaces may be different. Different image parameters may have the same type of vector space, but the different image parameters may have different unit vectors. For example, a color accuracy image parameter and an exposure image parameter may both have corresponding vector spaces of the just-noticeable difference (JND) type, but the different image parameters'respective JND spaces may have different unit vectors.

In one implementation, the vector space includes a JND space. A JND space may include a vector space where two locations separated by a unit vector correspond to image parameter values that are barely detectable (i.e., “just noticeable”) by a human. As an example, a captured image may include a color accuracy image parameter value of 5 in a JND space. The captured image may be modified such that the color accuracy image parameter value in the JND space is 6. Because the difference between the first and second image parameter values in the JND space is 1 (the unit vector), in about half the cases, a human may notice a difference in the color accuracy between the original image and the modified image. However, in a second example, a captured image may include a color accuracy image parameter value of 5 in the JND space, and the captured image may be modified such that the color accuracy image parameter value in the JND space is 5.4. Because the difference between the first and second image parameter values in the JND space is less than 1, the likelihood that a human notices a difference in the color accuracy between the original image and the modified image is smaller. In some implementations, the vector space may include another type of vector space into which image parameter values of block 420 can be converted.

Converting an image parameter value into a JND space may include converting an image parameter value for color accuracy into a JND space measured in delta-E. Delta-E may be linear in a JND space.

At block 440, processing logic converts each image parameter value in the vector space of the one or more parameter values in the vector space into a respective raw score of one or more raw scores. Converting an image parameter value in the vector space into a raw score may include using an algorithm, mathematical function, or another operation to convert the image parameter value in the vector space into the raw score.

In one implementation, converting the image parameter value in the vector space into the raw score includes using a logistic function to convert the image parameter value in the vector space. Using a logistic function may provide a bounded output (e.g., between 0 and 1). Furthermore, using the logistic function may provide a sigmoid, S-shaped curve, which may effectively fit many image parameters. Converting the image parameter value in the vector space into the raw score may include using some other type of function.

In some implementations, a raw score derived from an image parameter value of a first image capture device 106 (e.g., via the process of block 410-440) may be comparable to a raw score derived from an image parameter value of a second image capture device 106, which may allow a user to compare the performance of the two image capture devices 106 regarding the image parameter. As an example, a first image capture device 106 may capture an image, and processing logic may perform blocks 410-440 to generate a raw score of 0.8 for the color accuracy image parameter. A second image capture device may capture the same image, and processing logic may perform blocks 410-440 to generate a raw score of 0.6 for the color accuracy image parameter. Thus, a user may compare the first image capture device's 106 raw score of 0.8 and the second image capture device's 106 raw score of 0.6 and determine that the first image capture device 106 performs better regarding color accuracy.

At block 450, responsive to a raw score of the one or more raw scores not satisfying a threshold score, processing logic causes a corrective action associated with the image parameter corresponding to the image parameter value from which the raw score was derived to be performed. Each image parameter may include a corresponding threshold score. A raw score not satisfying the corresponding threshold score may indicate poor performance by the image capture device 106 that captured the image from which the raw score was derived. A raw score not satisfying the corresponding threshold score may indicate that the image capture devices should be adjusted. In one or more implementations, the raw score not satisfying the corresponding threshold score may include the raw score falling below the threshold score (e.g., where a higher raw score indicates better performance) or may include the raw score exceeding the threshold score (e.g., where a lower score indicates better performance).

In some implementations, causing the performance of the corrective action includes causing a command to be provided to the image capture device 106. The command may include data configured to cause the image capture device 106 to adjust the image parameter corresponding to the image parameter value from which the raw score was derived. The data configured to cause the image capture device 106 to adjust may include the data identifying the image parameter that should be adjusted, the raw score for the image parameter, the threshold score for the image parameter, or other data. For example, the image quality manager 104 may send a command to the image capture device 106, and the command may indicate to the image capture device 106 that the color accuracy image parameter should be adjusted. The image capture device 106 may obtain the command, and the software or firmware of the image capture device 106 may adjust one or more configurations of the image capture device 106 (e.g., hardware configurations or software/firmware configurations) in an attempt to increase future raw scores corresponding to the color accuracy image parameter.

In one or more implementations, causing the performance of the corrective action includes adjusting the image parameter of the captured image, corresponding to the image parameter value from which the raw score was derived. For example, the image quality manager 104 may determine that the raw score for the exposure image parameter is below the threshold score corresponding to the exposure image parameter. In response, the image quality manager 104 may adjust the captured image by using image processing operations to adjust the exposure image parameter to increase the raw score corresponding to exposure and, thus, increase the quality of the captured image. The image quality manager 104 may provide the adjusted captured image to a downstream software application (e.g., a virtual meeting application, as discussed below).

In some implementations, processing logic causes a virtual meeting UI to present the captured image in a first region of the virtual meeting UI during a virtual meeting between one or more participants. The first region may correspond to a participant of the one or more participants. The captured image may include the captured image with the adjusted image parameter. As an example, the captured image may include a frame of a media stream (e.g., a video stream) generated by the image capture device 106 during a virtual meeting. The image quality manager 104 may perform the method 400 on each frame of the media stream in order to adjust the frames of the media stream and improve the image quality of the images captured by the image capture device 106. The image quality manager 104 may adjust the frames in real-time during the virtual meeting. Real-time adjustment refers to the ability to modify a frame instantly without computational delays and/or with negligible (e.g., milliseconds) latency.

In some implementations, processing logic combines the one or more raw scores generated at block 440. Combining the one or more raw scores may include using the one or more raw scores to calculate an overall raw score. The overall raw score may indicate an overall image quality of the captured image. The image quality manager 104 may combine one or more overall raw scores for different captured images to generate an overall raw score for the image capture device 106.

In some implementations, combining the one or more raw scores for the captured image includes combining the one or more raw scores as a weighted average. The image quality manager 104 may provide one or more weights used to calculate the weighted average. The one or more weights may be provided by user input to the client device 102 or the image quality server 110. The weighted average may indicate an overall score for the captured image.

In one implementation, processing logic causes an overall raw score to be presented on a UI. The overall raw score may include a weighted average for a captured image, another type of overall raw score for the captured image, or an overall raw score for the image capture device 106. For example, the image quality manager 104 may cause a display device of the client device 102 or the image quality server 110 to display a UI, and the UI may present information about an image quality of a captured image or the image captured device 106. The image quality manager 104 may cause the UI to present the overall raw score. A user of the client device 102 or the image quality server 110 may associate the overall raw score with the image capture device 106 and compare the overall raw score to a similarly calculated overall raw score of another image capture device 106 in order to compare an image quality of the two image capture devices 106. In some implementations, the image quality manager 104 causes the UI to present the one or more raw scores used to calculate the overall raw score on the UI.

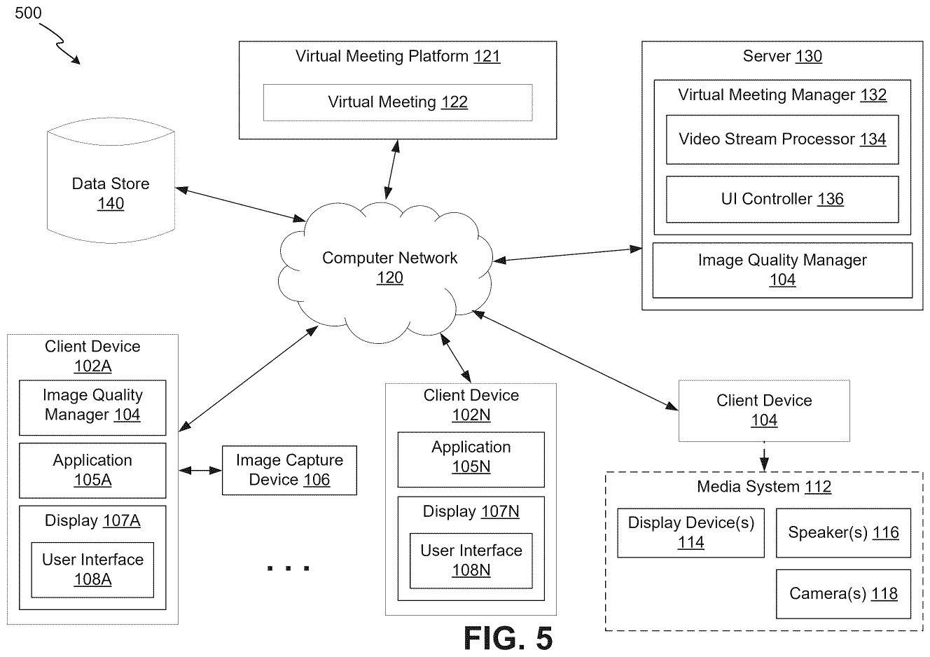

FIG. 5 illustrates an example system architecture 500, in accordance with implementations of the present disclosure. The system architecture 500 includes one or more client devices 102A-N or 104, the computer network 120, a virtual meeting platform 121, a server 130, and a data store 140.

In some implementations, the virtual meeting platform 121 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds) latency. The virtual meeting platform 121 can allow a user of the virtual meeting platform 121 to join and participate in a virtual meeting 122 with other users of the virtual meeting platform 121 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 121 or the virtual meeting manager 132 collects user information (e.g., information about a user's social network, social actions or activities, profession, a user's preferences, or a user's current location), or to control whether or how to receive content from the virtual meeting platform 121 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 121 or the virtual meeting manager 132.

In some implementations, the server 130 includes a server computing device. The server 130 may include the image quality server 110 of the system 100 of FIG. 1, or the server 130 may include a different server computing device. The server 130 may include a virtual meeting manager 132. The virtual meeting manager 132, in one or more implementations, is configured to manage a virtual meeting 122 between multiple users of the virtual meeting platform 121. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-N by the client applications 105A-N executing on the operating systems of the client devices 102A-N, 104. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured to receive video streams from one or more of the client devices 102A-N, 104. The video stream processor 134 may be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the video stream processor 134 receives audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can display a video stream pertaining to one or more participants of the virtual meeting 122. The UI controller 136 can control which video stream is to be displayed by providing a command to one or more client devices 102A-N, 104 that indicates which video stream is to be displayed in which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

In one or more implementations, the virtual meeting manager 132 includes the image quality manager 104. The image quality manager 104 may perform one or more of the operations of the method 400, as discussed above. For example, in block 410, the image quality manager 104 may obtain a captured image from the video stream processor 134. The image quality manager 104 may perform the operations of block 420-450. As discussed above, the image quality manager 104 may adjust one or more image parameters of a captured image. The image quality manager 104 may then provide the captured image, with one or more adjusted image parameters, to the UI controller 136 to be provided to the one or more client devices 102A-N, 104.

In some implementations, each of the virtual meeting platform 121 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 121 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 120). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107A-N of a client device 102A-N or a UI (e.g., a UI of the UIs 108A-N), one or more features of the application 105A-N for users to access the virtual meeting platform 121. For example, a user of client device 102A can join and participate in the virtual meeting 122 via a UI 108A presented on the display device 107A by the application 105A. The user can present a document to participants of the virtual meeting 122 using the UI 108A. Each of the UIs 108A-N can include multiple regions to present visual items corresponding to video streams of the client devices 102A-N provided to the server 130 for the virtual meeting 122.

In some implementations, a client device 102A-N or 104 includes the client device 102 of the system 100 of FIG. 1. A client device 102A-N may include a respective image capture device 106. A camera 118 of a media system 112 associated with the client device 104 may include an image capture device 106. A client device 102A-N, 104 may include the image quality manager 104. The image quality manager 104 may perform one or more of the operations of the method 400, as discussed above. For example, in block 410, the image quality manager 104 may obtain a captured image from an associated image capture device 106. The image quality manager 104 may perform the operations of block 420-450. As discussed above, the image quality manager 104 may adjust one or more image parameters of a captured image. The image quality manager 104 may then provide the captured image, with one or more adjusted image parameters, to the video stream processor 134.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 121 or one or more different machines (e.g., the server 130) coupled to the virtual meeting platform 121 using the network 120. In some implementations, the data store 140 stores portions of audio and video streams received from one or more client devices 102A-N, 104 for the virtual meeting platform 121. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users.

It should be noted that in some implementations, the functions of the virtual meeting platform 121 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 121.

In general, one or more functions described in the several implementations as being performed by the virtual meeting platform 121 or server 130 can also be performed by the client devices 102A-N, 104 in other implementations, if appropriate. In addition, in some implementations, the functionality attributed to a particular component can be performed by different or multiple components operating together. The virtual meeting platform 121 or the server 130 can also be accessed as a service provided to other systems or devices through appropriate application programming interfaces, and thus is not limited to use in websites.

Although implementations of the disclosure are discussed in terms of the virtual meeting platform 121 and users of the virtual meeting platform 121 participating in a virtual meeting 122, implementations can also be generally applied to any type of telephone call, conference call, or other technological communications methods between users. Implementations of the disclosure are not limited to virtual meeting platforms that provide virtual meeting tools to users.

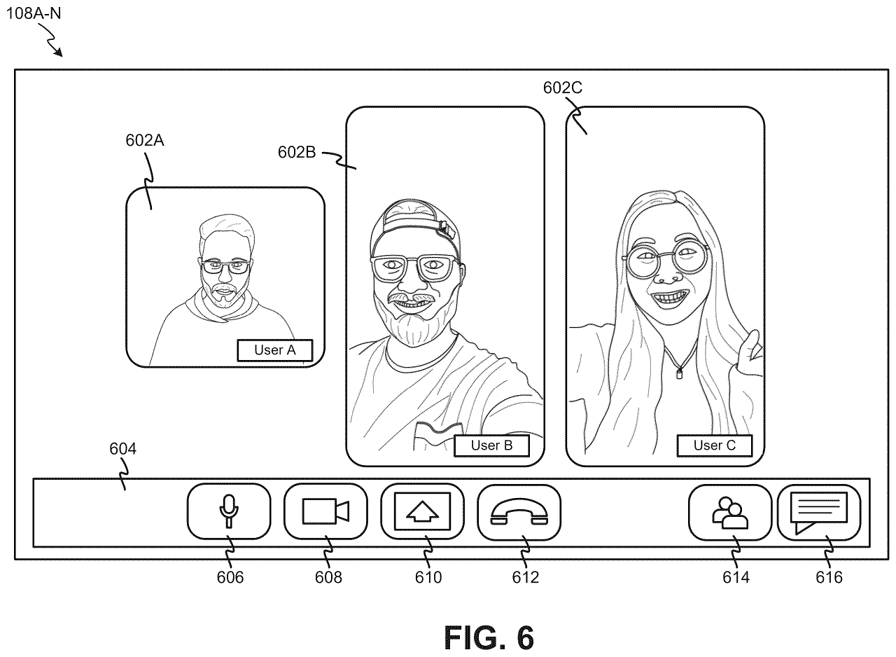

FIG. 6 depicts a virtual meeting UI 108A-N for a virtual meeting 122, in accordance with some implementations of the present disclosure. The virtual meeting UI 108A-N may include one or more regions 602A-C corresponding to a visual item of the virtual meeting 122, such as a video stream provided by a client device 102A-N, 104 of a participant of the virtual meeting 122. The virtual meeting UI 108A-N can include a toolbar 604 that includes one or more UI elements configured to perform virtual meeting operations. For example, as seen in FIG. 6, the toolbar 604 includes an audio control button 606 used to mute and unmute a participant's audio stream, a camera control button 608 used to mute and unmute a participant's video stream, a screen share button 610 used to share a participant's client device's 102A-N, 104 screen with other participants of the virtual meeting 122, and a disconnect button 612 used to leave or disconnect from the virtual meeting 122. The toolbar 604 may include a participants button 614 that can display a list of the one or more participants of the virtual meeting 122. The toolbar 604 may include a chat button 616 that can display a chat interface that allows participants of the virtual meeting 122 to send and receive chat messages in the virtual meeting 122.

In some implementations, a first region 602A of the virtual meeting UI 108A presents a visual item, which may include a video stream. The video stream may include one or more images captured by the image capture device 106 associated with a first client device 102A, and the one or more captured images may include images with one or more image parameters adjusted during the virtual meeting 122 by the image quality manager 104, as discussed above.

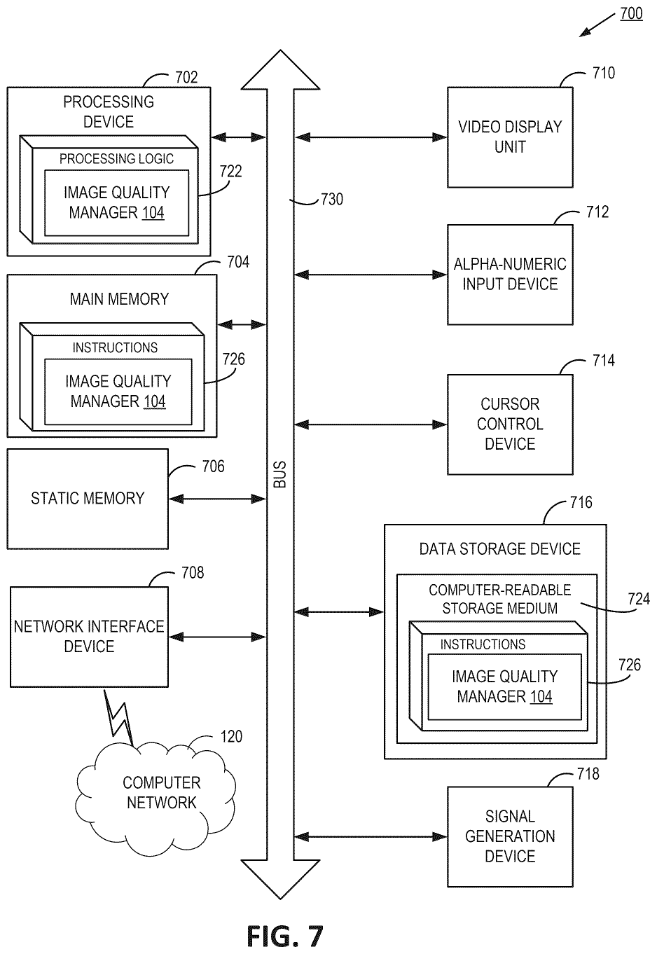

FIG. 7 is a block diagram illustrating an example computer system, in accordance with implementations of the present disclosure. The computer system 700 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute the processing logic 722 for performing the operations discussed herein (e.g., the operations of the image quality manager 104).

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (sometimes referred to as a “computer-readable storage medium”) on which is stored one or more sets of instructions 726 (e.g., the instructions to carry out one or more operations of the image quality manager 104) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over the computer network 120 via the network interface device 708.

In one implementation, the instructions 726 include instructions for determining visual items for presentation in a user interface of a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
obtaining an image captured by an image capture device;
obtaining data indicating a plurality of image parameter values, wherein each parameter value of the plurality of image parameter values corresponds to a respective image parameter of the captured image;
converting each image parameter value of the plurality of image parameter values into a respective vector space;
converting each image parameter value in the respective vector space of the plurality of image parameter values in the respective vector spaces into a respective raw score of a plurality of raw scores; and
responsive to a raw score of the plurality of raw scores not satisfying a threshold score, causing a corrective action associated with the image parameter corresponding to the image parameter value from which the raw score was derived to be performed.

2. The method of claim 1, wherein the image parameter corresponding to the image parameter value from which the raw score was derived comprises an exposure of the captured image.

3. The method of claim 1, wherein the image parameter corresponding to the image parameter value from which the raw score was derived comprises a color accuracy of the captured image.

4. The method of claim 1, wherein the image parameter corresponding to the image parameter value from which the raw score was derived comprises a sharpness of the captured image.

5. The method of claim 1, wherein the vector space comprises a just-noticeable difference (JND) space.

6. The method of claim 1, wherein causing the performance of the corrective action comprises causing a command to be provided to the image capture device that adjusts the image parameter corresponding to the image parameter value from which the raw score was derived.

7. The method of claim 1, wherein causing the performance of the corrective action comprises adjusting the image parameter of the captured image corresponding to the image parameter value from which the raw score was derived.

8. The method of claim 7, further comprising causing a virtual meeting user interface (UI) to present the captured image, with the adjusted image parameter, in a first region of the virtual meeting UI during a virtual meeting between a plurality of participants, wherein the first region corresponds to a participant of the plurality of participants.

9. The method of claim 1, further comprising:
combining the plurality of raw scores as a weighted average; and
causing the weighted average to be presented on a user interface (UI).

10. A system, comprising:
a memory; and
a processing device, coupled with the memory, configured to perform operations comprising:
obtaining an image captured by an image capture device,
obtaining data indicating a plurality of image parameter values, wherein each parameter value of the plurality of image parameter values corresponds to a respective image parameter of the captured image,
converting each image parameter value of the plurality of image parameter values into a respective vector space,
converting each image parameter value in the respective vector space of the plurality of image parameter values in the respective vector spaces into a respective raw score of a plurality of raw scores, and
responsive to a raw score of the plurality of raw scores not satisfying a threshold score, causing a corrective action associated with the image parameter corresponding to the image parameter value from which the raw score was derived to be performed.

11. The system of claim 10, wherein the image parameter corresponding to the image parameter value from which the raw score was derived comprises a noise of the captured image.

12. The system of claim 10, wherein the image parameter corresponding to the image parameter value from which the raw score was derived comprises a number of artifacts present in the captured image.

13. The system of claim 10, wherein the vector space comprises a just-noticeable difference (JND) space.

14. The system of claim 10, wherein causing the performance of the corrective action comprises causing a command to be provided to the image capture device that adjusts the image parameter corresponding to the image parameter value from which the raw score was derived.

15. The system of claim 10, wherein causing the performance of the corrective action comprises adjusting the image parameter of the captured image corresponding to the image parameter value from which the raw score was derived.

16. The system of claim 15, further comprising causing a virtual meeting user interface (UI) to present the captured image, with the adjusted image parameter, in a first region of the virtual meeting UI during a virtual meeting between a plurality of participants, wherein the first region corresponds to a participant of the plurality of participants.

17. A non-transitory computer-readable storage medium with instructions that, when executed by a processing device, cause the processing device to perform operations comprising:
obtaining an image captured by an image capture device;
obtaining data indicating a plurality of image parameter values, wherein each parameter value of the plurality of image parameter values corresponds to a respective image parameter of the captured image;
converting each image parameter value of the plurality of image parameter values into a respective vector space;
converting each image parameter value in the respective vector space of the plurality of image parameter values in the respective vector spaces into a respective raw score of a plurality of raw scores; and
responsive to a raw score of the plurality of raw scores not satisfying a threshold score, causing a corrective action associated with the image parameter corresponding to the image parameter value from which the raw score was derived to be performed.

18. The computer-readable storage medium of claim 17, wherein the image parameter corresponding to the image parameter value from which the raw score was derived comprises at least one of:
an exposure of the captured image;
a color accuracy of the captured image;
a sharpness of the captured image;
a noise of the captured image; or
a number of artifacts present in the captured image.

19. The computer-readable storage medium of claim 17, wherein the vector space comprises a just-noticeable difference (JND) space.

20. The computer-readable storage medium of claim 17, wherein causing the performance of the corrective action comprises causing a command to be provided to the image capture device that adjusts the image parameter corresponding to the image parameter value from which the raw score was derived.
